(19) United States
(12) Patent Application Publication
(10) Pub. No.: US 2010/0132522 A1
(43) Pub. Date: Jun. 3, 2010

(54) Trimmer

(76) Inventors: Michael E. Peterson, Fairfield, CT (US); Amy Campagna, Oxford, CT (US); James E. McCay, Fairfield, CT (US); John K. Clay, Milford, CT (US); Javier Verdura, Milford, CT (US)

Correspondence Address: WHYTE HIRSCHBOECK DUDEK S C;INTELLECTUAL PROPERTY DEPARTMENT, 555 EAST WELLS STREET, SUITE 1900, MILWAUKEE, WI, 53202, US

(21) Appl. No.: 12/562,754

(22) Filed: Sep. 18, 2009

Related U.S. Application Data
(60) Provisional application No. 61/098,582, filed on Sep. 19, 2008.
(60) Provisional application No. 61/192,655, filed on Sep. 19, 2008.

(51) Int. Cl. B26D 1/18; B26D 7/26; B26D 5/08

(52) U.S. Cl. 83/56; 83/859; 83/485; 83/481; 83/821

(57) ABSTRACT

A trimmer having a trimmer housing is disclosed. In accordance with at least some embodiments, the trimmer housing includes a first housing portion and a second housing portion, the first housing portion being pivotally connected at least indirectly to the second housing portion. The trimmer additionally includes a cutting platform having a first platform connected at least indirectly to the first housing portion and a second platform connected at least indirectly to the second housing portion. The trimmer is configured wherein the second housing portion is substantially stationary and the first housing portion rotates approximately in a 180 degree range of motion from a close position to an open position, such that a flat and continuous cutting surface formed by the first and the second platforms is obtained.

### CROSS-REFERENCE TO RELATED APPLICATION

This application claims the benefit of U.S. Provisional Patent Application No. 61/098,582, filed Sep. 19, 2008 and U.S. Provisional Patent Application Ser. No. 61/192,655 filed Sep. 19, 2008, entitled “Trimmer” each of which is hereby incorporated by reference in its entirety herein.

### FIELD OF THE INVENTION

The present invention relates to trimmers and, more particularly, to trimmers for cutting paper and related sheet or sheet-like material.

### BACKGROUND OF THE INVENTION

Devices for cutting and/or trimming sheet or sheet-like material including, for example, paper, cloth, wallpaper and the like are well known in the art. A variety of trimmers, including anvil and rotary type trimmers are commonly available and frequently employed for cutting and/or trimming the aforementioned materials. For example, a trimmer is disclosed in U.S. patent application Ser. No. 10/695,429, entitled “Rotary Trimmer” and filed on Oct. 28, 2003, which is incorporated by reference herein in its entirety.

Conventional trimmers, and particularly rotary-style trimmers, are often inadequate in at least some aspects. Specifically, oftentimes the conventional trimmers available and on the market today are generally expensive to own, frequently occupy a large working space (both during storage and operation), and/ or are difficult to transport. A need therefore exists for a versatile trimmer that would overcome these and other shortcomings.

It would be advantageous if a trimmer that is space-efficient, cost-efficient and light weight could be developed. It would additionally be advantageous if such a trimmer, while providing a relatively large working surface, would additionally provide an efficient cutting and/or trimming operation. Further still, it would be advantageous if the trimmer was portable and convenient to stow away, and in addition, had readily interchangeable blades.

### BRIEF SUMMARY OF THE INVENTION

In one aspect, the present invention relates to a trimmer. In accordance with at least some embodiments, the trimmer comprises a trimmer housing. The trimmer housing includes a first housing portion and a second housing portion, the first housing portion being pivotally connected at least indirectly to the second housing portion. The trimmer additionally includes a cutting platform having a first platform connected at least indirectly to the first housing portion and a second platform connected at least indirectly to the second housing portion. The trimmer is configured wherein the second housing portion is substantially stationary and the first housing portion rotates approximately in a 180 degree range of motion from a close position to an open position, such that a flat and continuous cutting surface formed by the first and the second platforms is obtained.

In another aspect, the present invention relates to a trimmer comprising a trimmer housing, the housing having a first housing portion and a second housing portion, the first housing portion at least indirectly pivotally connected to the second housing portion. The trimmer additionally comprises a cutting platform having (i) a first platform connected at least indirectly to the first housing portion; and (ii) a second platform connected at least indirectly to the second housing portion, the first platform pivotally connected at least indirectly to the second platform. A blade carriage guide rail pivotally connected to the second platform and a blade carriage for interchangeably carrying a cutting blade assembly are additionally provided. The blade carriage is slidably mounted to the blade carriage guide rail, such that the blade carriage can slide along the blade carriage guide rail to cut and/or trim a sheet or sheet-like material positioned on the cutting platform.

In yet another aspect, a method of using a trimmer is disclosed. The method comprises providing (i) a trimmer housing, the housing having (a) a first housing portion; and (b) a second housing portion, the first housing portion at least indirectly pivotally connected to the second housing portion; (ii) a cutting platform having: (a) a first platform connected at least indirectly to the first housing portion; and (b) a second platform connected at least indirectly to the second housing portion, the first platform pivotally connected at least indirectly to the second platform; (iii) a blade carriage guide rail pivotally connected to the second platform; and (iv) a blade carriage for interchangeably carrying a cutting blade assembly, the blade carriage slidably mounted to the blade carriage guide rail. The method additionally comprises pivotably moving the first housing portion to obtain one of a working configuration and a storage configuration.

In still other aspects, the present invention relates to a trimmer comprising a trimmer housing, the housing having: (i) a first housing portion; and (ii) a second housing portion, the first housing portion at least indirectly pivotally connected to the second housing portion; at least one locking member for locking the first housing portion with the second housing portion; and a cutting platform having: (i) a first platform connected at least indirectly to the first housing portion; and (ii) a second platform connected at least indirectly to the second housing portion, the first platform pivotally connected at least indirectly to the second platform. The trimmer additionally comprises a blade carriage guide rail pivotally connected to the second platform; a blade carriage for interchangeably carrying a cutting blade assembly, the blade carriage slidably mounted to the blade carriage guide rail; and a blade guide locking mechanism rotatably mounted onto the blade carriage guide rail for locking and unlocking the blade carriage guide rail. The trimmer further comprises sliding the blade carriage along the blade carriage guide rail to cut and/or trim a sheet or sheet-like material positioned on the cutting platform.

In a further aspect, the present invention relates to a trimmer comprising a trimmer housing having a (i) a first housing portion; and (ii) a second housing portion, the first housing portion connected at least indirectly to the second housing portion. The trimmer additionally includes a cutting platform having (i) a first platform connected at least indirectly to the first housing portion; and (ii) a second platform connected at least indirectly to the second housing portion, and a blade guide locking mechanism for securing a sheet or sheet-like material onto the cutting platform. The blade guide locking mechanism comprises a rotatable rod having flanges at end portions thereof, and an actuator rotatably mounted onto the rotatable rod for facilitating rotation of the rotatable rod, wherein rotation of the rotatable rod causes the flanges to interact with members on the first platform to secure the sheet or sheet-like material.

In an alternate aspect, the present invention relates to a blade guide locking mechanism. The blade guide locking mechanism comprises a rotatable rod having flanges connected at end portions thereof, and an actuator rotatably mounted onto the rotatable rod for facilitating rotation of the rotatable rod, wherein rotation of the rotatable rod causes interaction of the flanges with additional structures to secure a sheet or sheet-like material in position.

Other aspects and embodiments are contemplated and considered within the scope of the invention.

### BRIEF DESCRIPTION OF THE DRAWINGS

Embodiments of the invention are disclosed with reference to the accompanying drawings and these embodiments are provided for illustrative purposes only. The invention is not limited in its application to the details of construction or the arrangement of the components illustrated in the drawings. Rather, the invention includes other embodiments and/or can be practiced or carried out in other ways. The drawings illustrate a best mode presently contemplated for carrying out the invention. Like reference numerals are used to indicate like components. In the drawings:

FIGS. 1A and 1B are top perspective views of a trimmer showing a trimmer housing in a storage configuration, the trimmer housing having a first housing portion and a second housing portion connected together in operational association, as well as housing a blade carriage, in accordance with at least some embodiments of the present invention;

FIGS. 2A-2C show top (FIGS. 2A-2B) and perspective (FIG. 2C) views of the trimmer of FIG. 1 in a working configuration, and illustrate the blade carriage and a blade guide locking assembly mounted on a blade carriage guide rail, in accordance with at least some embodiments of the present invention;

FIG. 3 is an end perspective view of the rotary trimmer of FIG. 1, showing transition from the storage configuration of FIG. 1 to the working configuration of FIG. 2, in accordance with at least some embodiments of the present invention;

FIG. 4 is a bottom plan view of the rotary trimmer of FIG. 2, in accordance with at least some embodiments of the present invention;

FIG. 5A is a top perspective view of the working configuration of the trimmer of FIG. 2, with the blade guide locking assembly in a raised position, in accordance with at least some embodiments of the present invention;

FIG. 5B shows a portion of the trimmer with the blade guide locking assembly in a closed position;

FIG. 5C shows an enlarged detailed view of a portion of the trimmer taken along line 5C-5C of FIG. 5B;

FIG. 5D shows a portion of the trimmer of FIG. 5A with the blade guide locking assembly in an open position;

FIG. 5E is a cross-sectional view taken along lines 5E-5E of FIG. 5B;

FIG. 6 is a front view of the blade carriage having a cutting blade assembly mounted thereon, in accordance with at least some embodiments of the present invention;

FIGS. 7A and 7B show a detailed view of the cutting blade assembly of FIG. 6 in accordance with at least some embodiments of the present invention;

FIGS. 8A-8F show various aspects of the use and/or operation of the trimmer, with FIG. 8C being a cross-sectional view taken along lines 8C-8C of FIG. 5C showing the blade carriage guide rail in a locked position and with FIGS. 8D and 8E showing the guide rail being shown unlocked from the locked position, in accordance with at least some embodiments of the present invention; and

FIGS. 9A-9C show cross-sectional views, with FIG. 9A taken along lines 9A-9A of FIG. 8A and FIGS. 9B and 9C being similar to FIG. 9A, and illustrating various aspects of the use and/or operation of a locking member of the trimmer of FIGS. 1A and 1B, in accordance with at least some embodiments of the present invention.

### DETAILED DESCRIPTION OF THE INVENTION

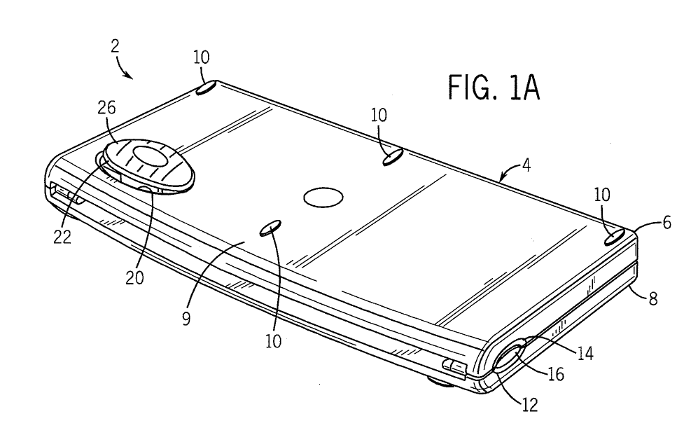

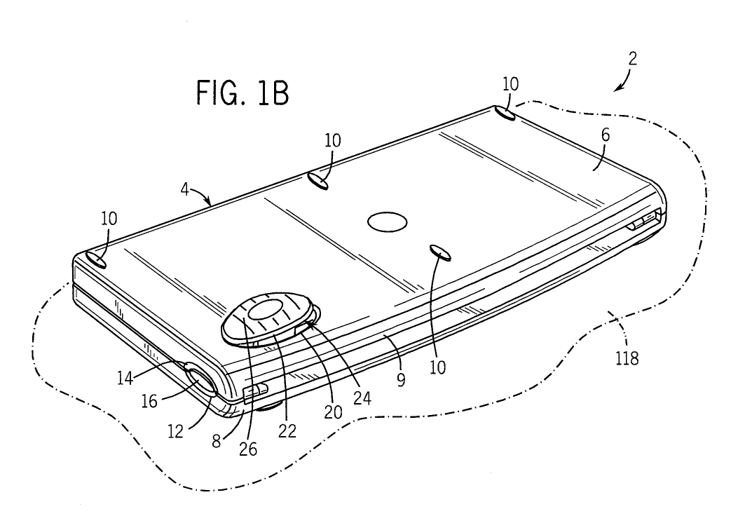

Referring to FIGS. 1A and 1B, top perspective views of an exemplary trimmer 2 are shown in accordance with at least some embodiments of the present invention. As illustrated, the trimmer 2 includes a trimmer housing 4 having a first housing portion 6 and a second housing portion 8. In at least some embodiments, and as shown, the first housing portion 6 is pivotably connected at least indirectly to the second housing portion 8, in a manner described below. The trimmer housing 4 and particularly the first and the second housing portions 6 and 8, respectively, serve as supports or supporting frames for the trimmer 2, housing various components (again described further below), of the trimmer 2 and also protecting those components during storage and/or transportation of the trimmer.

As indicated above, FIGS. 1A and 1B show the trimmer 2 in a storage configuration, which as used herein is intended to describe a compact configuration of the trimmer when the trimmer is generally not in use. In particular, in the storage configuration, the first and the second housing portions 6 and 8, respectively of the trimmer housing 4 are folded together (e.g., one portion on top of another in a fashion that is similar to a laptop computer) for facilitating easy and convenient storage of the trimmer 2 without consuming a large amount of table or shelf space. Additionally, the storage configuration affords portability to the laptop trimmer 2 while protecting internal trimmer components from being damaged during stowing and/or transport. To the extent that the first and the second housing portions 6 and 8, respectively, are folded together in the storage configuration, the trimmer 2 can also be referred to as a “laptop trimmer” or “laptop-type trimmer”.

With regard to the material of construction of the trimmer housing 4, in at least some embodiments each of the first and the second housing portions 6 and 8, respectively, of the trimmer housing can be of a unitary construction. Thus, in some embodiments, the housing portions each can be constructed of a single piece of plastic. When constructed of plastic, a cost-effective and light-weight trimmer can be obtained. In other embodiments, other durable and rigid (or semi-rigid) materials such as wood, aluminum, steel, or other suitable materials can be employed for constructing each of the respective first and the second housing portions 6 and 8. In alternate embodiments, each of the housing portions 6 and 8 can be constructed of discrete (e.g., multiple) pieces of similar or dissimilar materials (e.g., a combination of one or more plastic components, plastic and aluminum components, etc.) connected together in operational association. In addition to the material(s) of construction, the shape and size of the first and the second housing portions 6 and 8, respectively, can vary to convenience. For example, in at least some embodiments, the trimmer 2 can have a profile similar to that of a laptop computer, with each of the first and the second housing portions 6 and 8, respectively, representing a half (or substantially half) of the trimmer and having a rectangular (or substantially rectangular) shape. In at least some other embodiments, and as shown, a front portion 9 of each of the first and the second housing portions can be arcuately shaped. Other shapes and sizes for each of the housing portions 6 and 8 are contemplated and considered within the scope of the present invention.

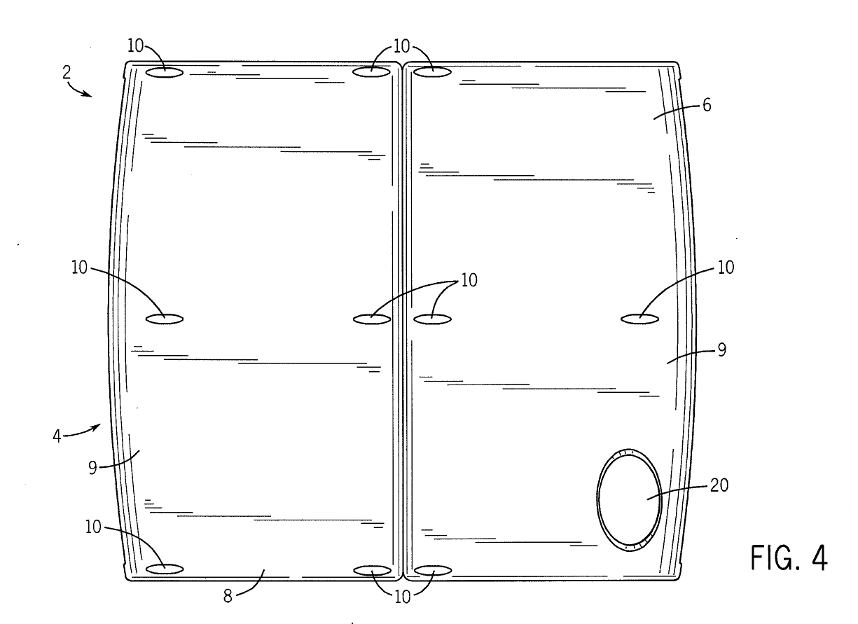

Furthermore, to provide a stable working surface in the working configuration, in at least some embodiments, each of the first and the second housing portions 6 and 8, respectively, can be equipped with a plurality of feet or feet-like structures 10 (only the feet on the first housing portion are visible in FIGS. 1A and 1B. See FIG. 4 for feet on the second housing portion). The plurality of feet 10 provide slip resistance and stability to the trimmer 2 with respect to the surface on which the trimmer is placed in the working configuration. In at least some embodiments, one or more of the plurality of feet 10 can comprise non-slip rubber pads, although other forms of non-slip materials and/or features can be employed in other embodiments. Furthermore, the number of the plurality of feet 10 on each of the first and the second housing portions 6 and 8, respectively, can vary. For example, although in the present embodiment, the first housing portion 6 has four feet, while the second housing portion has six feet, these numbers can vary to convenience in other embodiments. The shape and size of the plurality of feet 10 and similar structures can vary as well.

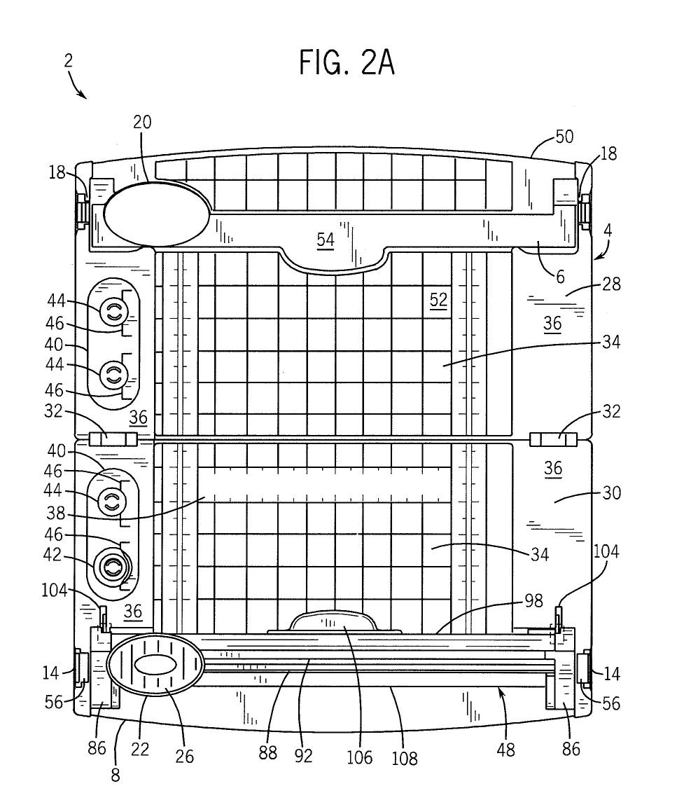

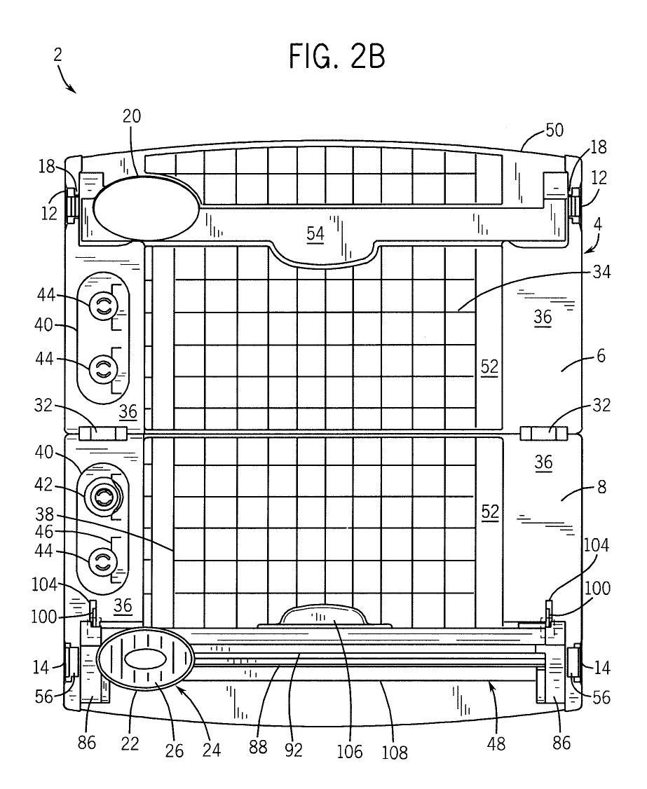

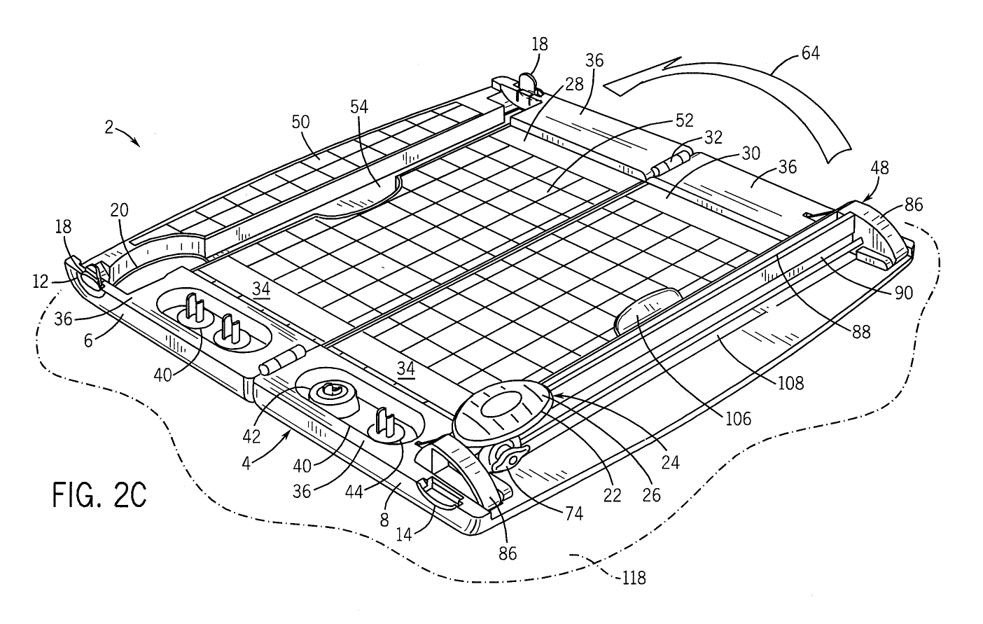

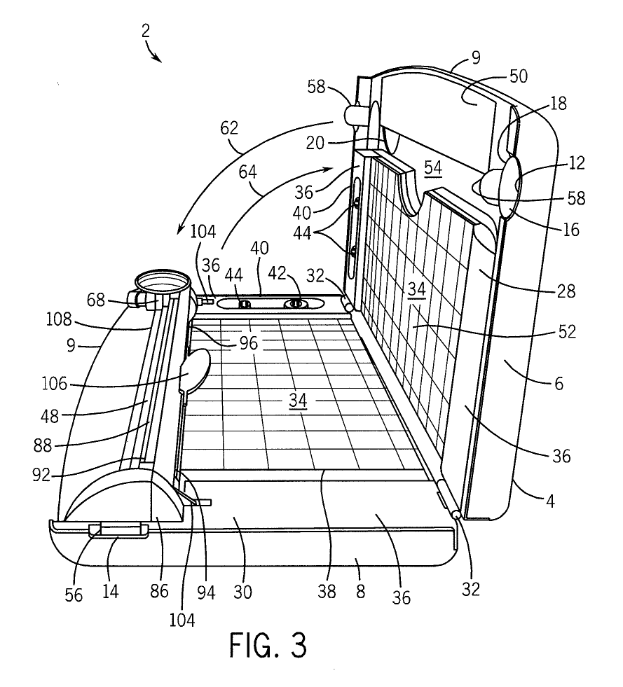

In addition to the plurality of feet 10, the first and the second housing portions 6 and 8, respectively, can have a plurality of cut-outs for accommodating various components of the trimmer 2 in the storage configuration. For example, in at least some embodiments and as shown, side portions adjacent to the front portion 9 of each of the first and the second housing portions 6 and 8, respectively, can be provided with a pair of respective corresponding arcuately shaped cut-outs 12 and 14. Each of the pair of the cut-outs 12 and 14 can be employed for accommodating a contact portion 16 of a locking member 18 (See. FIGS. 2 and 3). By virtue of actuating (e.g., depressing) the contact members 16, the trimmer 2 can be unlocked for facilitating a transition from the storage configuration to the working configuration, in a manner described below.

Along with the cut-outs 12, the first housing portion 6 is provided with another cut-out 20 formed on a top portion thereof In at least some embodiments, and as shown, the cut-out 20 can be an oval or substantially oval-shaped cut-out (e.g., a hole) for accommodating an arcuately-shaped handle portion 22 of a blade carriage 24 in the storage configuration (See FIG. 3). By virtue of providing the cut-out 20 and positioning the handle portion 22 through the cut-out, motion of the blade carriage 24 in the storage configuration is limited, thereby preventing any damage to the blade carriage during storage and/or transportation of the trimmer 2. It will be understood that although, in the present embodiment, the handle portion 22 is arcuately-shaped and the cut-out 12 is oval (or substantially oval) in shape to accommodate the arcuately-shaped handle portion, this need not always be the case. Rather, in other embodiments, the handle portion 22 can assume a different shape and the cut-out 20 can correspond to the shape of the handle portion. As further shown, the handle portion 22 can be equipped with a gripping surface (e.g., a non-slip rubber pad) 26 for providing a non-slip and comfortable gripping surface to an operator during handling the blade carriage 24.

Referring now to FIGS. 2A-2C, 3 and 4, various views of the trimmer 2 in the working configuration are shown, in accordance with at least some embodiments of the present invention. In particular, FIGS. 2A-2C show top perspective views of the trimmer 2 in the working configuration, while FIG. 3 shows an end view of the trimmer illustrating a transition from the storage configuration to the working configuration. FIG. 4 shows a bottom view of the trimmer 2 in the working configuration. As used herein, the working configuration of the trimmer 2 is intended to imply an “in-use” or operative configuration of the trimmer in which a cutting, trimming and/or shearing operation of a sheet or sheet-like material (referenced as “material” herein) can be facilitated utilizing the trimmer. Typically, in the working configuration, the first and the second housing portions 6 and 8, respectively, are positioned at (or substantially at) 180 degrees adjacent to one another such that a flat and continuous working surface is obtained.

As shown in FIGS. 2A-B and 3, the trimmer 2 includes a first cutting platform 28 secured to the first housing portion 6, and a second cutting platform 32 secured to the second housing portion 8. The term “platform” as used herein is intended to have a broad meaning to encompass any platform-like structure including a platform portion, a platform section and the like. Furthermore, in addition to being secured to the respective first and the second housing portions 6 and 8, respectively, the first and the second cutting platforms 28 and 30, respectively, are also pivotably (also referred to as pivotally) connected to one another at connection points 32.

In accordance with at least some embodiments of the invention, the pivot connection at the connection points 32 can include a male protrusion component on one cutting platform and a female receiving aperture on the other cutting platform such that the protrusion and the receiving aperture are positioned in mating alignment with one another for pivoting. In other embodiments, alternative pivotable connections that are readily available to and frequently employed by one skilled in the art can be used. Further, notwithstanding the fact that in the present embodiment, two connection points for pivotably connecting the first cutting platform 28 to the second cutting platform 30 have been disclosed, this need not be the case in other embodiments. Rather, more than two connection points 32 or even a single connection point for pivotally connecting the first cutting platform 28 and the second cutting platform 30 together are contemplated and considered within the scope of the present invention. Additionally, and as shown, the trimmer 2 is configured such that, in order to obtain the working configuration, only a portion (as shown, the first housing portion 6) of the trimmer has to be moved, while the other portion (as shown, the second housing portion 8) can remain stationary (or substantially stationary) on a flat surface 118 (See. FIG. 1B). Thus, in accordance with at least some embodiments, the first housing portion 6 rotates in or through a 180 degree (or substantially 180 degree) range of motion relative to the second housing portion 8 from a closed (e.g., storage and/or transport) configuration to an open (e.g., working and/or “in-use”) configuration such that a continuous, flat working surface formed by the first and the second cutting platforms 28 and 30, respectively, is obtained. Thus, to the extent that the first housing portion 6 is pivotally (e.g., hingedly) connected to the second housing portion 8 and the first housing portion rotates relative to the second housing portion, the first and the second housing portions can also be considered to be rotatably connected to one another.

Furthermore, and still referring to FIGS. 2A-B and 3, in at least embodiments, the first cutting platform 28 and the second cutting platform 30 can each be constructed with a recessed central base portion 34 flanked on either side by a protruded support portion 36. The central base portion 34 of the first and the second cutting platforms 28 and 30, respectively, provides a continuous (or substantially continuous), co-planar (or substantially co-planar) working area for securing and cutting/trimming the material. Additionally, the base portion 34 of the first and the second cutting platforms 28 and 30, respectively, has inscribed thereon various graduated metric and/or English units 38 for aiding the operator in aligning and/or measuring (e.g., as with or in the form of a ruler) the material to be cut, sheared, and/or trimmed. Grids of varying sizes and/or other measuring aids or indicia can be present as well. Further, the inscriptions can be present on the entire surface of the first and the second cutting platforms 28 and 30, respectively, or on portions thereof.

With respect to the protruded support portions 36 flanking the central base portions 34, these support portions serve at least several or multiple purposes. To begin with, by virtue of protruding with respect to the recessed base portions 34, the support portions serve as end-stops for preventing or minimizing movement of the material (e.g., due to slippage) during the cutting and/or trimming operation. In addition, the support portions 36 can be provided with storage 40 for storing various replacement parts, accessories and/or other tools to be employed in, as part of, or in conjunction with the trimmer 2. For example, in at least some embodiments, the storage 40 can be employed for storing one or more replacement cutting blade assemblies 42. To facilitate a secure storage of one or more of the replacement cutting blade assemblies 42, the storage 40 can be provided with special blade receiving structures 44 for receiving and securing the cutting blade assemblies in position and tab stops 46 for limiting motion of the assemblies during storage and transportation. Notwithstanding the fact that in the present embodiment, only storage for the replacement cutting blade assemblies 42 is shown, in other embodiments, other components can be stored as well. Furthermore, the storage 40 can take on various forms including, for example, storage bins, compartments with lids, pockets, tabs, channels, grooves etc. In alternate embodiments, other forms of the storage 40 are contemplated and considered within the scope of the present invention.

In addition to the aforementioned features, the first and the second cutting platforms 28 and 30, respectively, are equipped with additional features for facilitating proper operation of the trimmer 2 and also for protecting various components thereof. For example, the first cutting platform 28 is a specially designed structure that is divided into a first platform portion 50 and a second platform portion 52, both of which are separated from one another by a gap 54. By virtue of the special design of the first cutting platform 28, a blade carriage guide rail 48 positioned on the second cutting platform 30 can be accommodated in the gap 54, thereby preventing or minimizing movement thereof in the storage configuration. The gap 54 is additionally provided with the cut-out 20 for housing the handle portion 22 of the blade carriage 24 for protecting the blade carriage in the storage configuration, as described above.

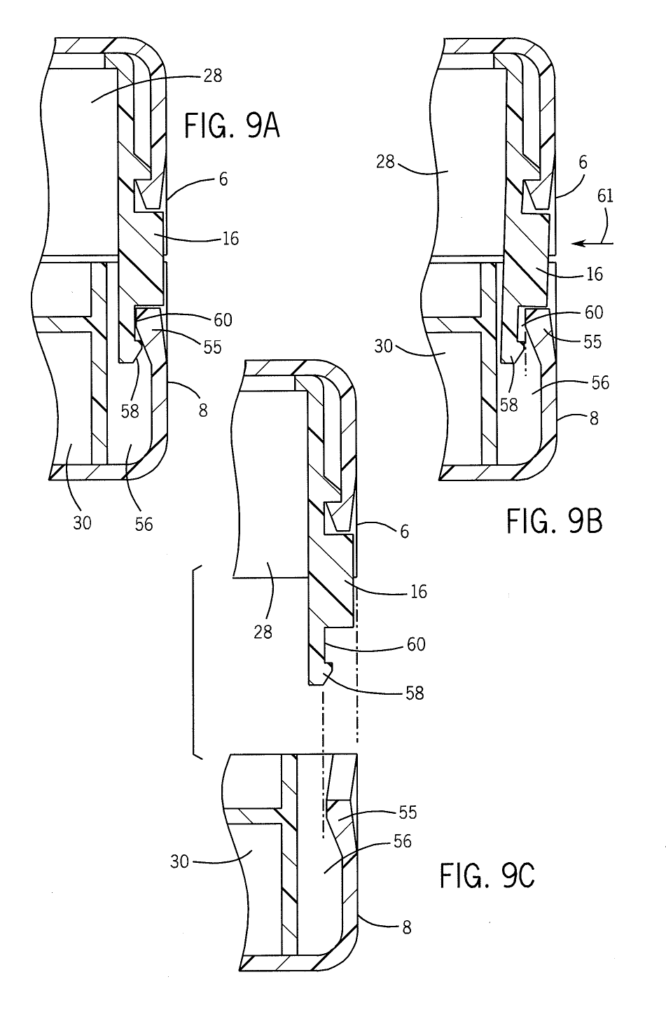

Further, along with the design noted above, the first cutting platform 28 is also equipped with the locking members 18 positioned adjacent each of the arcuately-shaped cut-outs 12. In at least some embodiments, the locking members 18 can be resilient structures integrally formed with the first cutting platform 28. In other embodiments, the locking members 18 can comprise separate components connected to the first cutting platform 28 in operational association. The locking members 18 interact with members 55 (See FIGS. 9A-9C) within corresponding recesses 56 positioned adjacent the cut-outs 14 in the second cutting platform 30 for facilitating transition of the trimmer 2 from the storage to the working configuration and vice-versa. Specifically, as indicated above, each of the locking members 18 are equipped with the contact portion 16 positioned in between the cut-outs 12 and 14 for facilitating locking and unlocking of the trimmer 2. In addition to the contact portion 16, each of the locking members 18 includes an extension portion 58 extending upwardly from the contact portion to lock and unlock the trimmer 2 upon actuation of the contact portion by the operator.

In particular, to facilitate locking and/or unlocking of the trimmer 2, the extension portion 58 of each of the locking members 18 has formed on an outer side (e.g., the side facing away from the cutting platform) thereof a groove 60 (only one of which is visible), which interacts with the members 55 (See FIGS. 9A-9C) in the corresponding recess 56 (only one of which is visible) on the second cutting platform 30 upon actuation of the contact portions 16. Specifically, and as shown in FIG. 3, to facilitate locking of the trimmer 2 (e.g., transition from working configuration to storage configuration), the first cutting platform 28 (and therefore the first housing portion 6 to which the first cutting platform is secured) can be pivotably rotated about the connection points 32 in a direction indicated by arrows 62 towards the second cutting platform 30 until the locking members 18 on the first cutting platform are received within the corresponding recesses 56 on the second cutting platform. Subsequently, the first housing portion 6 can be pressed downwardly to engage the grooves 60 of the locking members 18 with the members 55 within the recesses 56 to automatically lock the first housing portion 6 relative to the second housing portion 8, thereby locking the trimmer 2 as shown in FIG. 9A.

As shown in FIGS. 9B-9C, to unlock the trimmer 2 (e.g., to transition from the storage to the working configuration), the contact portion 16 of each of the locking members 18 can be pressed inwardly (e.g., in a direction indicated by arrow 61). By virtue of actuating (e.g., pressing) the contact portion 16 inwardly, the extension portions 58 and more particularly, the grooves 60 of the extension portions are disengaged from engagement with the members 55 in the corresponding recesses 56, thereby facilitating unlocking of the first housing portion 6 relative to the second housing portion 8. As shown in FIG. 9C, after actuating the contact portions 16, the working configuration can be obtained by rotating the first housing portion 6 in a direction indicated by arrow 64 (See FIG. 3) relative to the second housing portion 8. Rotation or pivoting of the first housing portion 6 will generally continue until the plurality of feet 10 rest on the flat supporting surface (e.g., table, counter, desk, etc.) 118 (See. FIG. 1B) such that a flat and continuous working surface formed by the first and the second cutting platforms 28 and 30, respectively, is obtained. By virtue of providing the locking members 18 capable of interacting (e.g., engaging/disengaging) with the corresponding recesses 56, locking and/or unlocking of the trimmer 2 can be facilitated in a manner similar to the locking and unlocking of a laptop computer. Notwithstanding the fact that in the present embodiment two locking members for facilitating locking/unlocking of the trimmer 2 have been provided, in alternate embodiments, a single locking mechanism similar to that of a laptop computer can be provided as well.

Referring still to FIGS. 2A-2C, 3, 4 and 6, the trimmer 2 utilizes the blade carriage 24, which is slidably mounted onto the blade carriage guide rail 48 (or guide rail, carriage guide, blade carriage guide and the like), for interchangeably carrying one or more cutting blade(s) 66 (See. FIG. 6). As shown specifically in FIG. 6, the blade carriage 24 includes an outer casing 68 integrally formed with the handle portion 22 and mounted to and in abutting contact with the blade carriage guide rail 48. By virtue of being mounted onto the blade carriage guide rail 48, the blade carriage 24 can be moved (e.g., slid) along a pre-defined path to facilitate a cutting and/or trimming operation. Additionally, in at least some embodiments, the casing 68 can be made of molded plastic, although in other embodiments, materials other than plastic including a light-weight metal (e.g., aluminum) can be used.

Furthermore, in at least some embodiments and as shown (particularly in FIG. 6), at least a portion of the casing 68 can be arcuately-shaped to accommodate the one or more cutting blade(s) 66 and, particularly, a cutting blade assembly 70 (described below) housing the one or more cutting blade(s), in position. More particularly, the casing 68 is provided with a shaft 72 onto which the cutting blade assembly 70 can be removably mounted for operation. A connector 74 can then be employed for securing the cutting blade assembly 70 in position. In at least some embodiments, the connector 74 can be a wing or wing-type connector at least partially made of plastic. In other embodiments, other types of connectors can be employed as well. Thus, by virtue of removably mounting the cutting blade assembly 70 onto the casing 68, the cutting blade assembly can easily be replaced when desired.

Specifically, the cutting blade assembly 70 can be replaced by first removing (e.g., by rotating 90 degrees or a quarter turn) the connector 74 that secures the cutting blade assembly (this may also refer to, in at least some instances, as a “hub” or “hub assembly”) in position onto the blade carriage 24. Subsequent to removing the connector 74, the cutting blade assembly 70 can be removed from the shaft 72 and replaced with a replacement cutting blade assembly (e.g., the cutting blade assembly 42 shown in FIG. 2). After replacement, the cutting blade assembly 70 can be mounted back onto the shaft 72 of the casing 68 and the connector 74 can be mounted back and rotated a quarter turn, thereby securing the cutting blade assembly in position. In at least some embodiments, the shaft 72 can take other forms (or include other mechanisms), including, for example, a bolt. Further, in addition to accommodating the cutting blade assembly 70, the casing 68 has provided on a rear portion thereof a protrusion 76, which is designed to be received in an aperture (not visible) on a side wall of the second cutting platform 30. By virtue of engaging the protrusion 76 within the aperture, the blade carriage 24 can be locked into position during the storage configuration. The locking of the blade carriage 24 into position as well as protruding the handle portion 22 through the cut-out 20 limits overall movement of the blade carriage, thereby protecting the blade carriage from damage in the storage configuration.

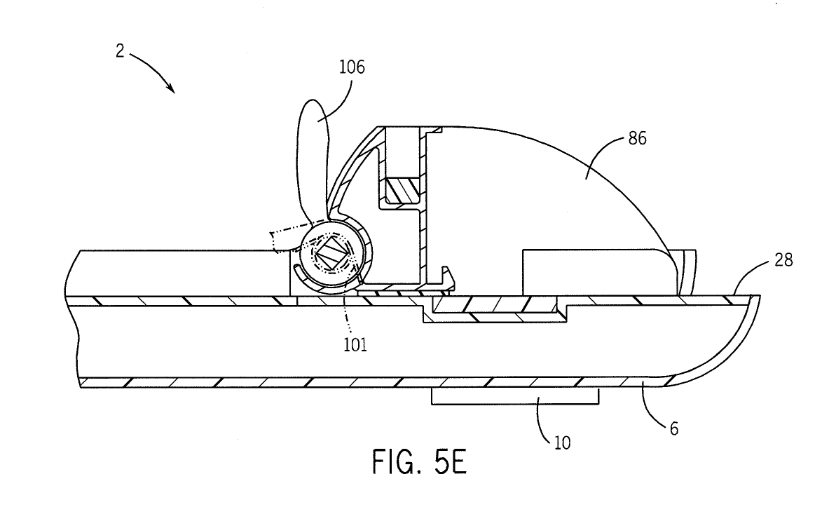

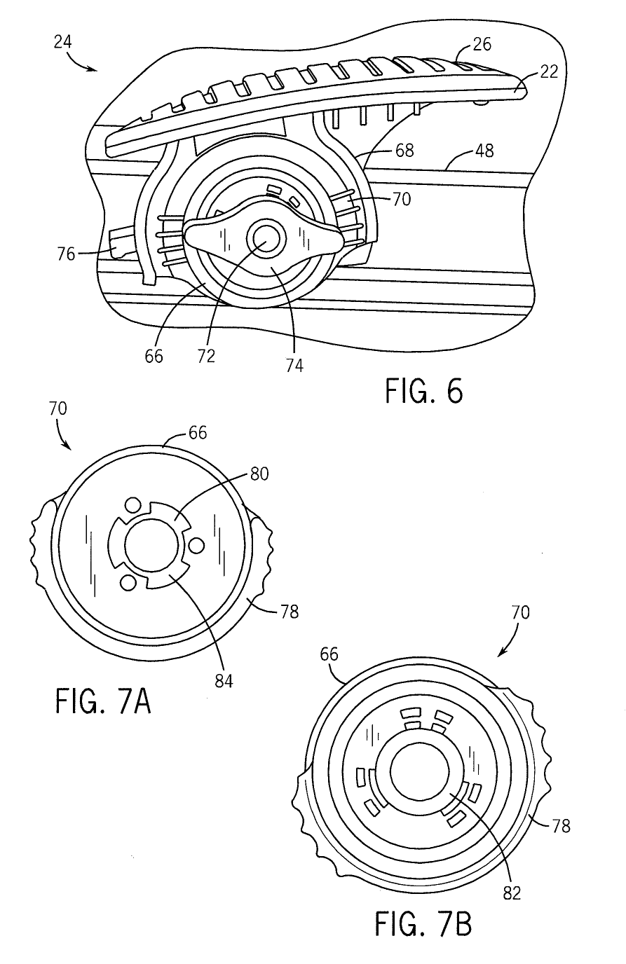

With respect to the cutting blade assembly 70 in particular, rear and front portions, respectively, of an exemplary cutting blade assembly are shown in FIGS. 7A and 7B. As shown, the cutting blade assembly 70 includes the cutting blade 66 substantially encompassed by a blade guard 78. The blade guard 78 protects the operator from direct exposure to the sharp edges of the cutting blade 66. To facilitate mounting of the blade guard 78 onto the cutting blade 66, each of the cutting blade and the blade guard are provided with apertures 80 and 82, respectively. The apertures 80 and 82 are positioned in mating alignment with one another and secured together in position by a connector 84. The connector 84 can be any of a wide variety of connectors including, for example, clips, nuts and bolts, screws, snap-on connectors, friction-fit connectors and the like. In other embodiments, other commonly employed mechanisms for securing the blade guard 78 to the cutting blade 66 can be employed as well. Thus, by virtue of connecting the blade guard 78 to the cutting blade 66, an integrally formed cutting blade assembly (e.g., the cutting blade assembly 70) is obtained that can be detachably mounted onto the blade carriage 24 for facilitating a cutting and/or trimming operation.

Furthermore, to provide a variety of different cutting operations, the cutting blade 66 can have any of a variety of shapes, sizes and/or configurations. For example, in at least some embodiments, the cutting blade 66 can be circular in shape (the trimmer 2 can thus be termed a rotary trimmer) having a sharp and rigid cutting edge for proving a smooth and even cut. In other embodiments, blades having a predefined cutting pattern or profile (e.g., a wave profile, a scalloped profile, a volcano profile, a bowtie profile, etc) or different types of blades such as those used for scoring paper can be used. Further, the cutting blade need not be circular in shape but rather, other shapes depending upon the embodiment can be employed. Additionally, the cutting blade(s) 66 can be coated with a variety of coatings including coatings described within the following commonly-owned U.S. patent and patent applications: patent application Ser. No. 60/870,787, filed on Dec., 19, 2006, “Cutting Implement”; patent application Ser. No. 11/231,259, filed Sep. 20, 2005, entitled “Coating for Cutting Implement”; U.S. Pat. No. 6,98.8,318 filed on Nov. 24, 2003, entitled “Coating for Cutting Implement”, and patent application Ser. No. 12/562,538, filed on Sep. 18, 2009 and entitled “Coating for Cutting Implements”; each of which is hereby incorporated in its entirety by reference herein, including any and all applications and patents related thereto. Further, a variety of other components can be associated with the cutting blade(s) 66 and/or the blade carriage 24 in other embodiments. For example, a biasing element (e.g., a metal spring) can act on the cutting blade(s) 66 within the blade carriage 24 when connected to the blade carriage guide to influence the disposition of the cutting blade with respect to the second cutting platform 30 to provide for a smooth cutting stroke.

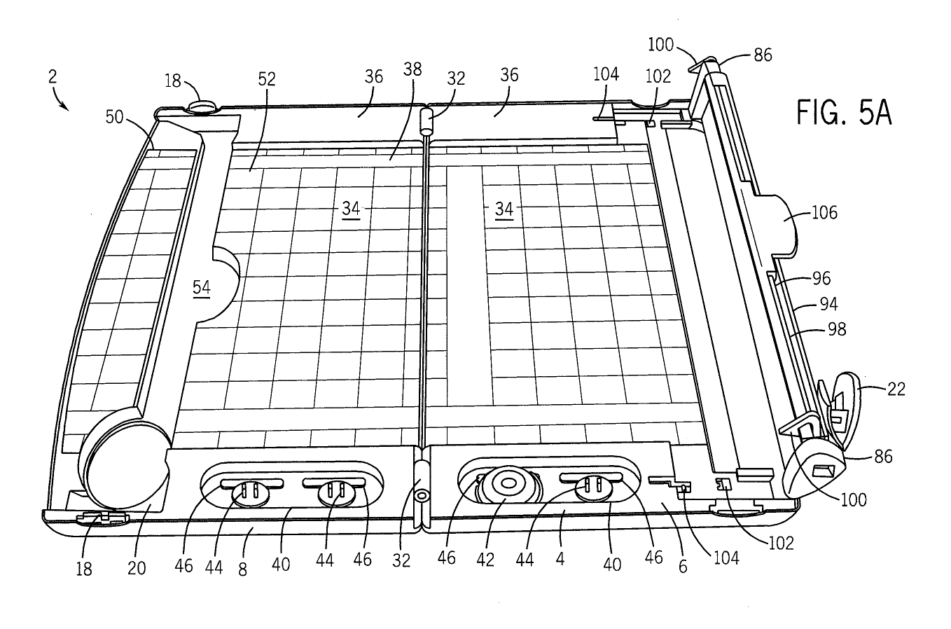

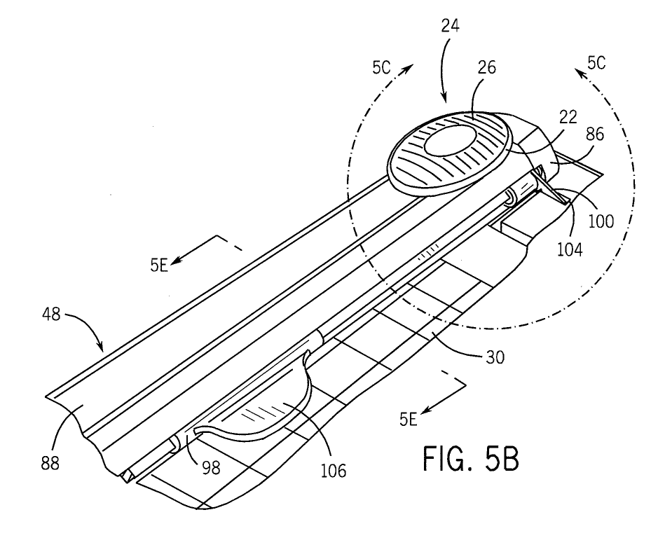

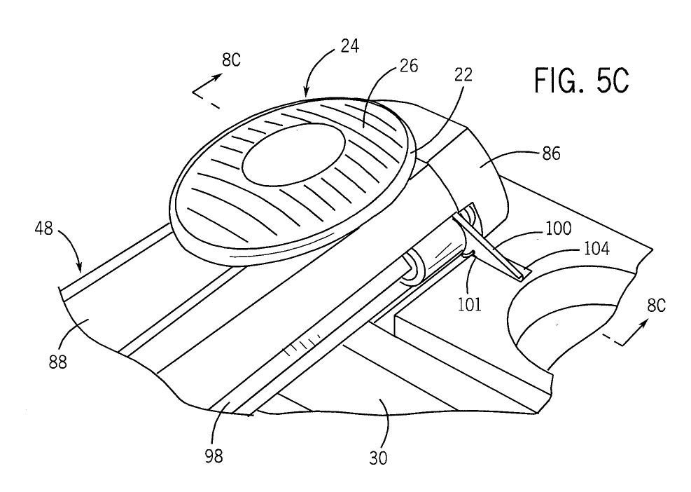

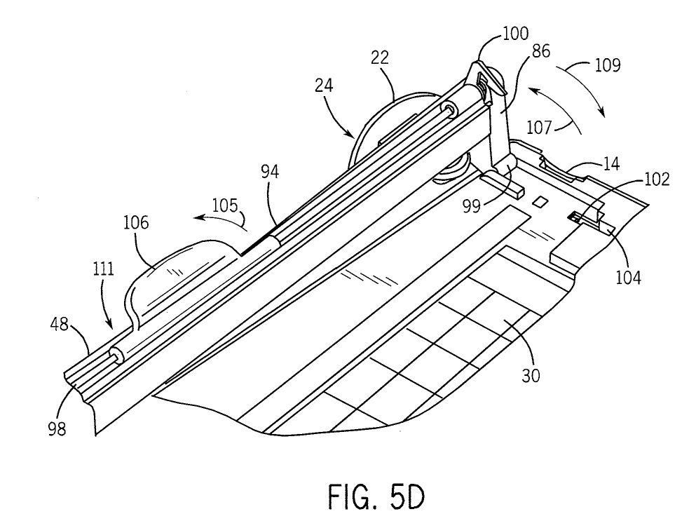

Referring now to FIGS. 5A-5E in conjunction with FIGS. 2A-2C, the blade carriage guide rail 48 is pivotably connected to the second cutting platform 30 via end portions 86 thereof As shown, the blade carriage guide rail 48 extends substantially the entire length of the second cutting platform 30 and is positioned parallel or substantially parallel to the second cutting platform. As indicated above, the blade carriage guide rail 48 is typically employed for slidably receiving the blade carriage 24 to move the blade carriage along a pre-defined cutting path to perform or accomplish a trimming and/or cutting operation on the material (as described further below). It will be understood that the terms trimming and/or cutting can include operations such as shearing, scoring and the like, and that such operations are contemplated and considered within the scope of the present invention.

To facilitate mounting of the blade carriage 24 and to ensure movement of the blade carriage along the pre-defined cutting path, the blade carriage guide rail 48, in at least some embodiments, can be provided with a top groove 88 on a top portion (e.g., portion facing away from the surface of the cutting platforms 28 and 30) and a first side groove 90 (See FIG. 6) on a side portion thereof adjacent the blade carriage. The grooves 88 and 90 extend substantially the entire length of the blade carriage guide rail 48 to ensure a focused movement of the blade carriage 24 along the pre-defined path for facilitating an accurate and a straight cut and/or trim operation. The groove 88 can additionally be equipped with a strip of a resilient material 92 (e.g., a rubber strip, shown in FIG. 2A) extending through the length of the groove for resiliently depressing the blade carriage 24 downwardly into the groove for applying greater pressure as desired on the material to be cut. Notwithstanding the particular arrangement of the blade carriage guide 24 described and shown in the present embodiment, in other embodiments, the positioning, size and/or shape of the blade carriage guide rail and the various components thereof can vary to convenience. In addition to the grooves 88 and 90 for mounting the blade carriage 24, the blade carriage guide rail 48 is equipped with a second side groove 94 (e.g., on the side opposing the side of the first side groove 90) for holding therein a blade guide locking assembly 96 (See FIG. 5A).

The blade guide locking assembly (also referred herein as blade guide locking mechanism) 96 can typically be employed for securing the material (e.g., the sheet or sheet-like material) in position during the cutting and/or trimming operation. In at least some embodiments and, as shown, the blade guide locking assembly 96 includes a rotatable rod 98. The rotation of the rotatble rod 98 facilitates locking and unlocking of the blade carriage guide rail 48 such that the blade carriage guide rail can be pivotally rotated about a pair of pivot points 99 for enabling the material to be positioned on the first and/or the second cutting platforms 28 and 30, respectively, for cutting and/or trimming.

Additionally, the blade guide locking assembly 96, which is described in greater detail below, need not always be employed in the embodiments of the trimmer 2 disclosed herein. Rather, as contemplated, the blade guide locking assembly 96 can be employed in a variety of trimmers including rotary-type trimmers and other trimmers, such as those that do not have foldable, pivotable and/or rotatable housing portions and/or cutting platform portions. By way of example and not of limitation, the blade guide locking assembly 96 as described herein may be suitable for the rotary trimmer of the aforementioned U.S. patent application Ser. No. 10/695,429.

Furthermore, to facilitate the locking and unlocking of the blade carriage guide rail 48, the rotatable rod 98 has connected at end portions thereof flanges 100. In at least some embodiments, the flanges 100 are connected to the rotatble rod via torsion spring 101, such that rotation of the rotatable rod causes rotation of the flanges. By virtue of rotation of the flanges 100, the flanges interact with members 102 within corresponding grooves 104 on the second cutting platform 30 to lock (or unlock) the blade carriage guide rail in position. Further, in at least some embodiments, each of the flanges 100 can be hook or substantially hook shaped to facilitate interaction with the members 102. Other hook-like structures or engagement mechanisms for facilitating engagement of the flanges 100 are additionally contemplated and considered within the scope of the present invention. The rotatable rod 98 has additionally attached in a central (or substantially central) portion thereof a rotatable actuator 106, the rotation of which causes the rotatable rod to rotate, which in turn facilitates locking (or unlocking) of the blade carriage guide rail 48.

Thus, as shown in FIG. 5D, to accomplish unlocking of the blade carriage guide rail 48, the actuator 106 is rotated upwardly, in a direction indicated by arrow 105 causing an upward rotation of the rotatable rod 98. By virtue of the rotation of the rotatable rod 98, the flanges 100 are disengaged from the members 102 within the corresponding grooves 104, thereby unlocking the blade carriage guide rail 48. Subsequent to unlocking the blade carriage guide rail 48, the blade carriage guide rail can be pivotally rotated about the pivot points 99 in a direction indicated by arrow 107 to obtain a raised (e.g., open) position thereof Typically, in the raised position, the blade carriage guide rail 48 is about 90 degrees to the second cutting platform 30 for positioning of the material on the first and/or the second cutting platforms 28 and 30, respectively, for facilitating a cutting and/or a trimming operation.

Referring still specifically to FIG. 5D, the blade carriage guide rail 48 can be locked into positioned by first pivotally rotating the blade carriage guide rail about the pivot points 99 in a direction indicated by arrow 109 until the flanges 100 are received within the corresponding grooves 104. Subsequently, the actuator 106 can be downwardly rotated (e.g., in the direction indicated by arrow 111) to rotate the rotatable rod 98 downwardly, which facilitates engagement of the flanges 100 with the members 102 in the grooves 104. By virtue of engagement of the flanges 100 with the members 102, the blade carriage guide rail 48 can be locked into position thereby securing the material positioned onto the first cutting platform 28 (See. FIGS. 2A-2C) and the second cutting platform 30 in the raised position of the blade carriage guide rail.

Furthermore, various refinements or changes to the features and components of the blade guide locking assembly disclosed herein are contemplated and considered within the scope of the present invention. For example, it is contemplated that one or more of the size, shape, design, geometry, orientation, and relative interconnection of one or more of the various components of the blade guide locking assembly may vary, and such variations are considered within the scope of the present invention.

In operation, and as shown in FIGS. 5A-5D, the material to be cut and/or trimmed is positioned and secured on the top surface of the first and/or the second cutting platforms 28 and 30, respectively. As indicated above, the material can be secured in position by unlocking the blade carriage guide rail 48 (in a manner described above) and then pivotally rotating the blade carriage guide rail in a raised position to position the material on the cutting platform(s). Subsequent to positioning the material on the cutting platform(s) 28, 30, the blade carriage guide rail 48 can be locked back into position, thereby securing the material for an even and smooth cut. Generally speaking, the material can be aligned in any direction and position with the aid of the grid units 38 on the base platform 34. Subsequently, actuation (e.g., sliding) of the blade carriage 24 along a pre-defined path provides for a cutting operation via the cutting blade(s) 66. In particular, a user can grasp the handle portion 22 of the blade carriage 24 to slide the blade carriage along the blade carriage guide rail 48 in both forward and backward directions. The sliding action of the blade carriage facilitates a cutting action by utilizing the cutting blade(s) 66 (See FIG. 6).

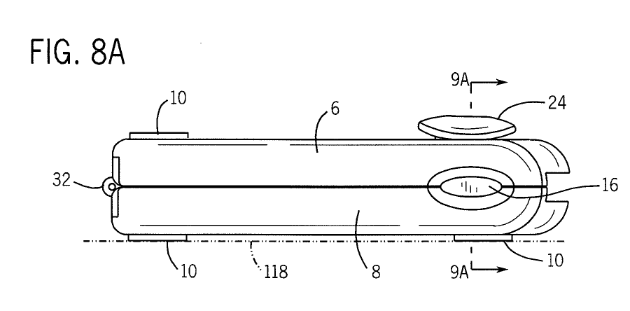

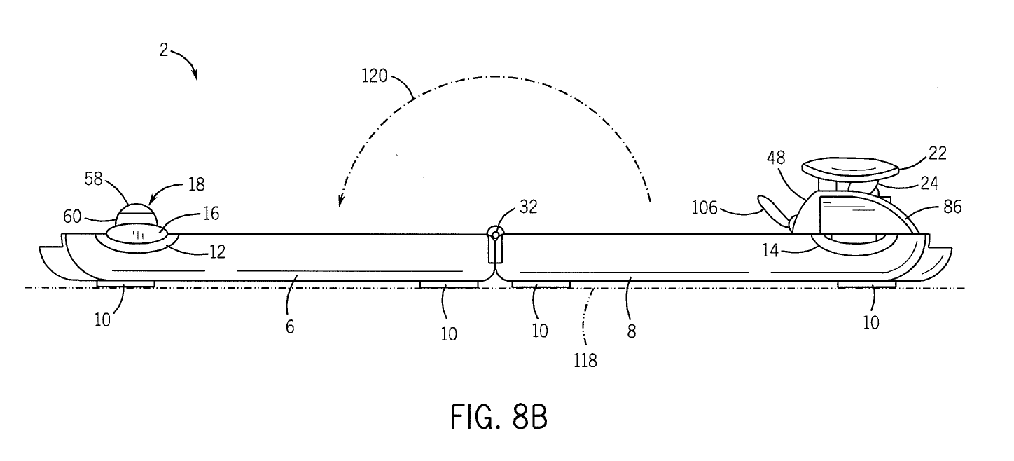

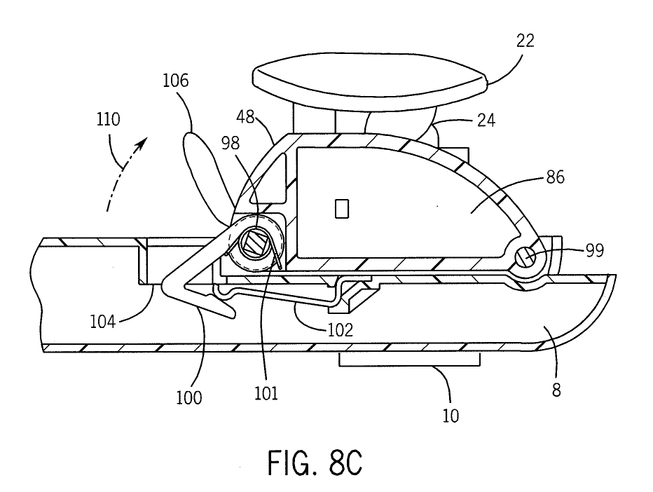

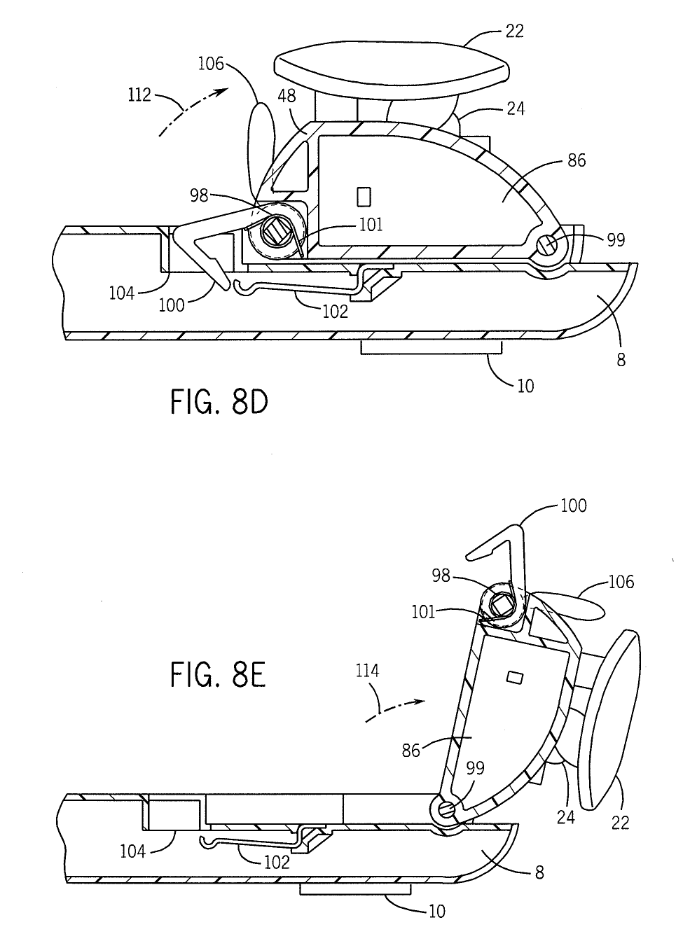

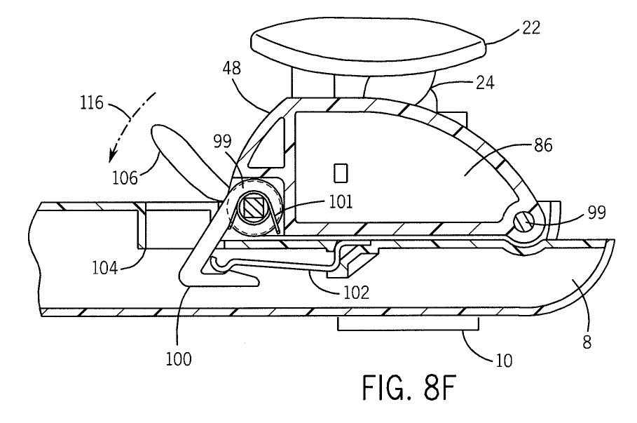

Particularly and as shown in FIGS. 8A-8F, in at least some embodiments, a method of positioning the trimmer 2 for operation is disclosed. The method of operation can encompass laying the trimmer 2 on a stable and flat surface (e.g., the flat surface 118), as shown, in FIG. 8A, for operation and then unfolding the trimmer in a working configuration as shown in FIG. 8B. More particularly, as discussed above, the working configuration of the trimmer 2 can be achieved by first actuating the contact member 16 to unlock the trimmer 2 and then pivotably moving the first housing portion 6 outwardly and away from the second housing portion 8 in a direction indicated by arrow 120 until a continuous and co-planar (or substantially co-planar) working surface formed by the first and the second cutting platforms 28 and 30, respectively, is obtained. It can be noted that the second housing portion 8 is kept stationary (or substantially stationary) on the flat surface 118 during rotation of the first housing portion 6.

Subsequently, the blade carriage guide rail 48 (or blade carriage guide rail assembly) can be unlocked and pivotally rotated in a raised position, as shown in FIGS. 8C-8F, for positioning the material to be trimmed and/or cut on the first and the second cutting platforms 28 and 30, respectively, in a manner described above. Specifically, as shown in FIGS. 8C and 8D, to facilitate unlocking of the blade carriage guide rail 48, the actuator 106 can be rotated in a direction indicated by arrows 110 and 112 to disengage the flanges 100 from the members 102 within the grooves 104. Subsequent to disengaging the flanges from the members 102, the blade carriage guide rail 48 can be rotated upwardly in a direction indicated by arrow 114, as shown in FIG. 8E, to obtain a raised position in which the material can be positioned. After positioning the material, the blade carriage guide rail 48 can be rotated until the flanges 100 are received within the grooves 104. Then, actuation (e.g., rotation) of the actuator in a direction 116 engages the flanges with the members 102, thereby locking the blade carriage guide rail in position. By virtue of securing the material in position, a smooth trimming and/or cutting operation can be achieved.

Subsequent to positioning the material and locking the blade carriage guide rail 48, the blade carriage 24 can be slid along the blade carriage guide rail in one or both directions for trimming and/or cutting the material. Additional downward pressure on the blade carriage 24 can be applied to facilitate a sharper and accurate cutting/trimming operation. A rubber strip 108 (See FIG. 3) beneath the cutting blade(s) 66 (See FIG. 6) on the second cutting platform 30 can be employed for preventing damage to the surface of the cutting platform below. Upon finishing trimming and/or cutting, the cut and/or trimmed material can be removed from the cutting platforms 28 and 30 (e.g., by unlocking and raising the blade carriage guide rail), and the trimmer 2 can be folded back into the storage configuration by folding the first housing portion 6 over the second housing portion 8 until the trimmer 2 has been locked into position.

Notwithstanding the embodiments of the trimmer 2 described above in relation to FIGS. 1-7B, other refinements to the features above including addition of various new features are encompassed within the scope of the present invention. For example, the sizes, shapes, orientations and the material of construction of the various components described above can vary from one embodiment to another. For example, although in the embodiments disclosed herein, the blade carriage guide rail 48 is pivotally connected at the two pivot points 99, in other embodiments, a single pivot point or more than two pivot points for pivotally rotating the blade carriage guide rail can be present. In alternative embodiments (although not shown), the cutting platforms can be slid or otherwise extended outwardly for achieving a larger (e.g., an extended) working platform while accommodating space limitations and additionally maintaining a substantially flat working surface. Also, the design of the various components can vary. Furthermore, it will be understood that the terms “pivotable”, “pivotal”, “pivoting” or similar terms are intended to have a broad meaning and encompass rotating, swinging, hinged or hinged-like and other similar movements.

Further, despite any method(s) being outlined in a step-by-step sequence, the completion of acts or steps in a particular chronological order is not mandatory. Further, modification, rearrangement, combination, reordering, or the like, of acts or steps is contemplated and considered within the scope of the description and claims.

It is specifically intended that the present invention not be limited to the embodiments and illustrations contained herein, but include modified forms of those embodiments including portions of the embodiments and combinations of elements of different embodiments as come within the scope of the following claims.

What is claimed is:

1. A trimmer comprising:
a trimmer housing having a (i) a first housing portion; and (ii) a second housing portion, the first housing portion pivotally connected at least indirectly to the second housing portion;
a cutting platform having (i) a first platform connected at least indirectly to the first housing portion; and (ii) a second platform connected at least indirectly to the second housing portion;
wherein the second housing portion is substantially stationary; and
wherein the first housing portion is capable of rotating through approximately a 180 degree range of motion from a closed position to an open position relative to the second housing portion, such that a flat and continuous cutting surface formed by the first and the second platforms is obtained.

2. The trimmer of claim 1, further comprising at least one locking member for locking and unlocking the first housing portion relative to the second housing portion.

3. The trimmer of claim 2, wherein each of the first and the second housing portions have formed therein corresponding arcuate cut-outs for accommodating the at least one locking member.

4. The trimmer of claim 2, wherein the first housing portion can be unlocked relative to the second housing portion by depressing the at least one locking member inwardly.

5. The trimmer of claim 1, wherein each of the first and the second housing portions have formed on an outer surface thereof a plurality of feet for providing stability to the trimmer in the open position.

6. The trimmer of claim 1, wherein the first housing portion has formed on a top surface thereof an arcuate cut-out for accommodating an additional component in the closed position.

7. The trimmer of claim 1, the trimmer having a profile similar to a laptop computer.

8. A trimmer comprising:
a trimmer housing, the housing having (i) a first housing portion; and (ii) a second housing portion, the first housing portion at least indirectly pivotally connected to the second housing portion;
a cutting platform having (i) a first platform connected at least indirectly to the first housing portion; and (ii) a second platform connected at least indirectly to the second housing portion, the first platform pivotally connected at least indirectly to the second platform;
a blade carriage guide rail pivotally connected to the second platform; and
a blade carriage for interchangeably carrying a cutting blade assembly, the blade carriage slidably mounted to the blade carriage guide rail;
wherein the blade carriage can slide along the blade carriage guide rail to cut and/or trim a sheet or sheet-like material positioned on the cutting platform.

9. The trimmer of claim 8, wherein the first platform and the second platform are at least substantially co-planar when the trimmer is in a working configuration to form a substantially continuous working surface.

10. The trimmer of claim 8, wherein the trimmer is re-configurable.

11. The trimmer of claim 10, wherein the trimmer has at least one of a portable configuration in which each of the first and the second housing portions are folded together, and a working configuration in which the first and the second platforms are co-planar or substantially co-planar with respect to the one another.

12. The trimmer of claim 11, wherein the working configuration is obtained by rotating the first housing portion through approximately a 180 degree range of motion relative to the second housing portion from the portable configuration, such that a flat and continuous cutting surface formed by the first and the second platforms is obtained.

13. The trimmer of claim 8, further comprising a blade guide locking mechanism for locking and unlocking the blade carriage guide rail in position.

14. The trimmer of claim 13, wherein the blade guide locking mechanism is mounted onto the blade carriage guide rail for operation.

15. The trimmer of claim 13, wherein the blade guide locking mechanism comprises:
a rotatable rod having flanges at end portions thereof;
an actuator rotatably mounted onto the rotatable rod for facilitating rotation of the rotatable rod;
wherein rotation of the rotatable rod causes the flanges to interact with members on the first platform to facilitate locking and unlocking of the blade carriage guide rail.

16. The trimmer of claim 8, wherein the blade carriage guide rail extends parallel or substantially parallel to the base platform.

17. The trimmer of claim 8, wherein the cutting blade assembly comprises:
at least one cutting blade; and
a blade guard assembly substantially encompassing the at least one cutting blade.

18. The trimmer of claim 8, further comprising a pair of locking members for locking and unlocking the trimmer, each of the pair of locking members comprising:
a first portion;
a second portion extending from the first portion;
wherein actuation of the first portion causes the second portion to interact with an additional member to facilitate locking and unlocking of the trimmer.

19. A method of using a trimmer, the method comprising:
providing (i) a trimmer housing, the housing having: (a) a first housing portion; and (b) a second housing portion, the first housing portion at least indirectly pivotally connected to the second housing portion; (ii) a cutting platform having: (a) a first platform connected at least indirectly to the first housing portion; and (b) a second platform connected at least indirectly to the second housing portion, the first platform pivotally connected at least indirectly to the second platform; (iii) a blade carriage guide rail pivotally connected to the second platform; and (iv) a blade carriage for interchangeably carrying a cutting blade assembly, the blade carriage slidably mounted to the blade carriage guide rail; and
pivotably moving the first housing portion to obtain one of a working configuration and a storage configuration.

20. The method of claim 19, wherein moving the first housing portion to obtain the working configuration comprises:
actuating a locking member to unlock the first housing portion from the second housing portion;
swinging the first housing portion outwardly away from the second housing portion until the first and the second platforms are at least substantially co-planar to form a substantially continuous working surface.

21. The method of claim 19, wherein moving the first housing portion to obtain the storage configuration comprises:
rotating or swinging the first housing portion inwardly towards the second platform until the first and the second housing portions are folded together.

22. The method of claim 19, further comprising:
securing a material to be trimmed and/or cut on the cutting platform;
sliding the blade carriage along the blade carriage guide rail to facilitate a cutting and/or a trimming operation of the material positioned on the cutting platform.

23. The method of claim 22, wherein securing the material on the cutting platform can be facilitated by:
unlocking the blade carriage guide rail;
pivotally rotating the unlocked blade carriage guide rail in a raised position;
positioning the material on the cutting platform; and
locking the blade carriage guide rail to secure the material in position.

24. The method of claim 23, wherein locking and unlocking of the blade carriage rail guide comprises:
providing a blade guide locking mechanism rotatably mounted onto the blade carriage guide rail; and
rotating a rotatable rod of the blade guide locking mechanism for facilitating locking and unlocking of the blade carriage guide rail.

25. A trimmer comprising:
a trimmer housing, the housing having: (i) a first housing portion; and (ii) a second housing portion, the first housing portion at least indirectly pivotally connected to the second housing portion;
at least one locking member for locking the first housing portion with the second housing portion;
a cutting platform having: (i) a first platform connected at least indirectly to the first housing portion; and (ii) a second platform connected at least indirectly to the second housing portion, the first platform pivotally connected at least indirectly to the second platform;
a blade carriage guide rail pivotally connected to the second platform;
a blade carriage for interchangeably carrying a cutting blade assembly, the blade carriage slidably mounted to the blade carriage guide rail; and
a blade guide locking mechanism rotatably mounted onto the blade carriage guide rail for locking and unlocking the blade carriage guide rail;
wherein the blade carriage can slide along the blade carriage guide rail to cut and/or trim a sheet or sheet-like material positioned on the cutting platform.

26. The trimmer of claim 25, wherein each of the first and the second platforms comprises:
a recessed central base portion;
a pair of protruded side support portions flanking the base portion;
wherein the base portion has inscribed thereon one or more grids and units for facilitating the positioning of the sheet or the sheet-like material.

27. The trimmer of claim 26, wherein at least one of the pair of the side support portions has formed therein a storage for storing one of replacement parts and accessories.

28. A trimmer comprising:
a trimmer housing having a (i) a first housing portion; and (ii) a second housing portion, the first housing portion connected at least indirectly to the second housing portion;
a cutting platform having (i) a first platform connected at least indirectly to the first housing portion; and (ii) a second platform connected at least indirectly to the second housing portion;
a blade guide locking mechanism for securing a sheet or sheet-like material onto the cutting platform, the blade guide locking mechanism comprising:
a rotatable rod having flanges at end portions thereof;
an actuator rotatably mounted onto the rotatable rod for facilitating rotation of the rotatable rod;
wherein rotation of the rotatable rod causes the flanges to interact with members on the first platform to secure the sheet or sheet-like material.

29. A blade guide locking mechanism comprising:
a rotatable rod having flanges connected at end portions thereof;
an actuator rotatably mounted onto the rotatable rod for facilitating rotation of the rotatable rod;
wherein rotation of the rotatable rod causes interaction of the flanges with additional structures to secure a sheet or sheet-like material in position.

30. The blade guide locking mechanism of claim 29, wherein the flanges are connected to the rotatable rod via a torsion spring.

31. The blade guide locking mechanism of claim 29, wherein the flanges are hook or substantially hook shaped.

32. The blade guide locking mechanism of claim 29 for use with the trimmer of claim 1.

33. The blade guide locking mechanism of claim 29 for use with the trimmer of claim 8.

34. The blade guide locking mechanism of claim 29 for use with the trimmer of claim 34.

35. A trimmer comprising a first housing portion, a second housing portion, and a cutting surface, and wherein at least one of the first housing portion and the second housing portion is capable of pivoting and/or rotating at least about 180 degrees with respect to the other of the first housing portion and the second housing portion so as to at least partially expose and/or at least partially conceal the cutting surface.
